(19) United States
(12) Patent Application Publication
(10) Pub. No.: US 2025/0350143 A1
(43) Pub. Date: Nov. 13, 2025

(54) BATTERY CHARGING DEVICE AND METHOD OF CONTROLLING A BATTERY CHARGING DEVICE

(71) Applicants: BORGWARNER ORSENIGO S.R.L., ORSENIGO (COMO) (IT); DR. ING. H.C. F. PORSCHE AG, STUTTGART (DE)

(72) Inventors: Stefano DATTILO, Orsenigo (Como) (IT); Francesco BERTINO, Orsenigo (Como) (IT); Pasquale FORTE, Orsenigo (Como) (IT); Paolo LISANTI, Orsenigo (Como) (IT)

(21) Appl. No.: 18/861,092

(22) PCT Filed: Apr. 28, 2023
(86) PCT No.: PCT/IB2023/054416

§ 371 Date: Oct. 28, 2024

(30) Foreign Application Priority Data
Apr. 29, 2022 (IT) 102022000008612

(51) Int. Cl. H02J 7/04

(52) U.S. Cl. CPC H02J 7/04

(57) ABSTRACT

A battery charging device connectable to the power grid, comprising a power outlet provided with a plurality of terminals connectable to the power grid, a corresponding plurality of voltage sensors associated with respective nodes connected to the terminals and a processing unit configured for receiving voltage signals from the sensors, processing said voltage signals so as to extract, for each signal, a first and a second value representing a module and a phase shift of the voltage flowing in the respective node, comparing said first and second values with respective reference values representing the modules, phase shifts, and natural frequencies of a plurality of types of power grids and, based on that comparison, determining the type of power grid to which the battery charging device is connected, selecting the type of grid to which said first and second values correspond.

### BACKGROUND

### Technical Field

This invention relates to a battery charging device and a method of controlling a battery charging device.

This invention finds its main and preferred application in the automotive field, in particular in the design and manufacture of charging systems for electric batteries. In the context of electric vehicles, in fact, the battery pack charging mode is divided into two distinct relative macro-categories: on-board chargers and ground chargers.

On-board chargers are, as their name suggests, integrated into the vehicle and include all the power and control electronics needed to convert the alternating current from the mains into the direct current needed to charge the battery pack.

On the other hand, ‘ground’ chargers are the well known ‘columns’ or wallboxes that directly perform the conversion by supplying the vehicle with direct current.

It is, therefore, clear that battery chargers of both categories, having to manage an alternating current coming from the mains and having to convert it into direct current for charging high-voltage batteries, present considerable critical issues in terms of user safety, as they must be equipped with appropriate protection systems.

It seems, therefore, clear that battery chargers in the automotive sector must necessarily ‘know’ the type of mains to which they are connected in order to be able to efficiently perform both charging and safety procedures.

The quality of the grounding is in fact one of the most important parameters to be monitored during a charging phase, as it is decisive in guaranteeing maximum user safety.

To do this, however, it is necessary for the charging device to be able to determine the type of grid to which it is connected, something that is certainly not trivial in view of the fact that there are more than twenty different types of grid in the world, which, depending on the connection mode, can give rise to an even greater number of cases.

### BRIEF SUMMARY

It is, therefore, the purpose of this invention to provide a battery charging device and a method of controlling a battery charging device capable of avoiding the above-mentioned drawbacks of the prior art.

In particular, one purpose of this invention is to provide a battery charging device and a method of controlling a battery charging device that is highly versatile and capable of ensuring maximum efficiency and safety for all types of power grids known today.

Said purposes are achieved with a battery charging device and a control method for a battery charging device having the characteristics listed in one or more of the following claims.

In particular, said purposes are achieved with a battery charging device connectable to the power grid, comprising a current socket provided with a plurality of terminals connectable to the power grid, a corresponding plurality of voltage sensors associated with respective nodes connected to the plurality of terminals, and a processing unit.

Preferably, the power outlet is provided with a first, a second, a third and a fourth terminal connectable to the three phases and the neutral of a three-phase network; these terminals may, however, not be used for different types of networks.

The device further comprises, as mentioned above, the plurality of voltage sensors respectively associated with a first, a second, a third and a fourth node connected respectively to said first, second, third and fourth terminal.

Preferably, said voltage sensors are configured to generate respective voltage signals, more preferably a first, a second, a third and a fourth voltage signal each representing a voltage value at the respective node;

The processing unit is configured to process said voltage signals so as to extract, for each signal, a first and a second value representing a modulus and a phase shift of the voltage flowing at the respective node.

In particular, the processing unit is preferably configured to receive said first, second, third and fourth voltage signal and to process said voltage signals so as to extract, for each signal, a first and a second value representing a modulus and a phase shift of the voltage flowing at the respective node.

The processing unit is also, preferably, configured to compare the first and second values with respective reference values representing the modules, phase shifts and natural frequencies of a plurality of types of power grids and to determine, based on said comparison, the type of power grid to which the battery charging device is connected, by selecting the type of grid to which said first and second values correspond.

More preferably, the processing unit is arranged to configure the topology of the charging device and/or monitor the connection status of the device to the power grid depending on the type of power grid determined.

According to another aspect of the invention, the processing unit is configured to identify, according to said comparison, which of the first, second, third and fourth nodes is a neutral node connected to the neutral of the power grid and to monitor the first value of the voltage signal on said neutral node.

Preferably, the control unit is configured to compare said first value with the corresponding reference value of the type of power grid determined and to identify an earth disconnection or earthing degradation condition when a difference between the first value of the voltage signal at the neutral node and the corresponding reference value exceeds a predetermined threshold value.

In response to the identification of said earth disconnection or earthing degradation condition, an alarm signal is generated or a disconnection from the grid is given.

Another purpose of this invention is to provide a method of controlling a battery charging device connected to the power grid.

The method comprises detecting a first, a second, a third and a fourth voltage signal on a first, a second, a third and a fourth node associated with respective socket terminals and representing three phase nodes and a neutral node.

The voltage signals are then processed so as to extract, for each signal, a first and second value representing a modulus and phase shift of the voltage flowing at the respective phase or neutral node.

These first and second values are then compared with respective reference values representing the modules, phase shifts and natural frequencies of multiple types of power grids.

The type of electrical network to which the battery charging device is connected is then determined based on said comparison, selecting the type of grid to which said first and second values correspond, and checking the charging device by adapting it to the type of power grid determined.

The dependent claims, incorporated herein by reference, correspond to different embodiments of the invention.

### BRIEF DESCRIPTION OF THE DRAWING

Further features and advantages of this invention will become clearer from the illustrative, and therefore non-limiting, description of a preferred but not exclusive embodiment of a battery charging device and a method of controlling a battery charging device as illustrated in the accompanying drawings wherein:

FIG. 1 schematically shows a battery charging device according to this invention.

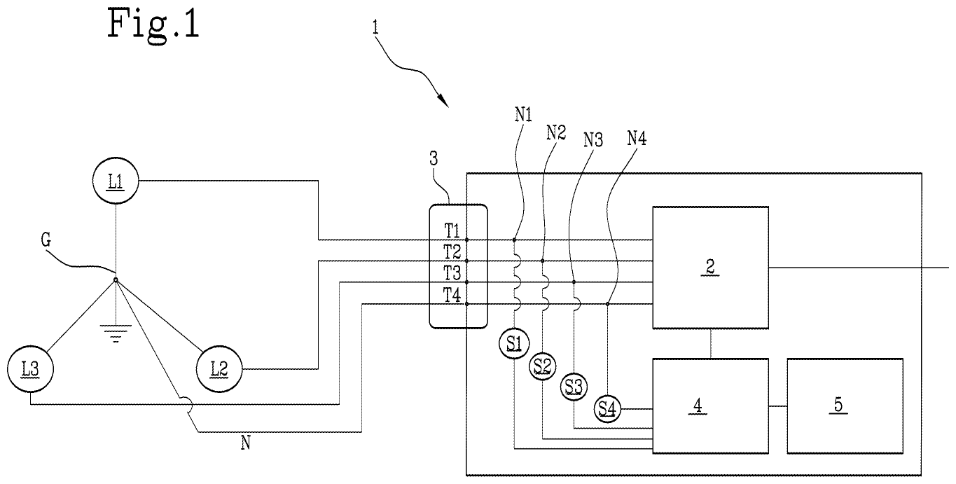

### DETAILED DESCRIPTION

With reference to the appended figures, a battery charging device according to this invention, preferably an automotive one, is generically identified with the reference number 1.

The term “battery charging device” means, in this text, generically, any charging system for a traction battery pack capable of connecting to the alternating current power grid and converting the alternating current into direct current before supplying power to the battery.

The charging device 1 thus comprises a power outlet 3 connected to a converter assembly 2 configured to convert the alternating current from a power grid G to which the outlet is connected into a suitably modulated direct current for recharging the battery pack (not illustrated) and possibly activating low-voltage loads (not illustrated).

The power outlet 3 is provided with a plurality of terminals; in particular, the power outlet 3 comprises a first T1, a second T2, a third T3 and a fourth terminal T4.

In use, the terminals are connectable to the phases L1, L2, L3 and to the neutral N of the three-phase power grid; alternatively, however, only some (at least two) of the terminals are connected to the grid, leaving the others inactive, depending on the type of power grid to which the device 1 is connected.

Preferably, therefore, the device 1 comprises a plurality of voltage sensors S1, S2, S3, S4 each associated with a node N1, N2, N3, N4 connected to a respective terminal T1, T2, T3, T4.

The nodes N1, N2, N3, N4 are, therefore, electrically connected to the terminals T1, T2, T3, T4.

In more detail, the device comprises a first N1, a second N2, a third N3 and a fourth N4 node connected, respectively, to said first T1, second T2, third T3 and fourth terminal T4.

More preferably, the voltage sensors S1, S2, S3, S4 are associated with the first N1, second N2, third N3, and fourth N4 node and connected, respectively, between said first T1, second T2, third T3, and fourth T4 terminal and a chassis of the device 1.

The voltage sensors S1, S2, S3, S4 are, thus, configured to generate a first, a second, a third and a fourth voltage signal each representing a voltage value at the respective node.

The voltage sensors are of a known type, which will not be detailed in the following as well known by an engineer in the field.

The device 1 further comprises a processing unit 4 associated with the voltage sensors S1, S2, S3, S4.

The processing unit 4 is configured to receive said first, second, third and fourth voltage signal and process them.

In particular, the processing unit is configured to transform said voltage signals in the frequency domain according to known functions, extrapolating significant parameters for each signal.

In the preferred embodiment, said processing involves the adoption of a sliding discrete Fourier transform (SDFT), but another type of transform could also be exploited. Preferably, the processing unit 4 is configured to process said voltage signals so as to extract, for each signal, a first and a second value representing a modulus and a phase shift of the voltage flowing in the respective node N1, N2, N3, N4.

It should be noted that, for nodes not connected to the grid, these values could also be zero; moreover, for single-phase power grids, the phase shift would be considered zero. Even the presence of null values, therefore, contains information for the purposes of this invention.

The processing unit is, therefore, configured to compare said first and second values with respective reference values representing the modules, phase shifts and natural frequencies of a plurality of types of power grids.

Preferably, in this regard, the device 1 further comprises a database 5 containing a plurality of parameters identifying each type of power grid.

In particular, the database (or possibly the matrix or map) is structured in such a way as to associate with each power grid type reference values representing one or more of the following parameters (preferably all of them):
a plausibility range or a point value of the voltage modulus of each phase node (L1, L2, L3) and neutral node (N)
a plausibility range or a point value of a phase shift between the voltages of the phase node (L1, L2, L3) and/or neutral node (N);
a plausibility range or point value of the grid frequency.

Note that, preferably, the database 5 is structured in such a way as to assign a range or point value to all parameters, assigning a null value to the parameters of unconnected nodes.

Preferably, the grid types identified by the database are at least the following:
Single-phase;
Two-phase;
Three-phase;
Split-phase;
Triangle.

Each of said grid types is also preferably divided into a plurality of sub-categories representing specific cases of outlet connection (reverse or normal) or connection.

The database 5 is thus associated with (i.e. in communication with) the processing unit 4 in order to provide it with reference values.

Preferably, in this regard, the processing unit 4 is configured to determine the type of power grid G to which the battery charging device 1 is connected according to the comparison between the first and second values representing the voltage signals and the reference values contained in the database 5.

Preferably, the processing unit 4 configured to compare each first or second value with the corresponding reference value of each grid type.

In other words, the processing unit 4 will, in use, compare the first or second signal representing the voltage at a given node with all corresponding reference values related to that node within each grid type.

Proceeding thus for all first and second values, the processing unit 4 is able to uniquely identify the grid type to which the device 1 is connected.

In particular, the processing unit 4 is configured to select the type of network in which said first and second values of the voltage signals correspond (barring a predetermined tolerance).

By means of this selection/determination, the processing unit 4 is able to configure the topology of the charging device 1 (and/or the converter assembly 2) and/or monitor the connection status of the device to the power grid G according to the type of power grid determined.

According to a further aspect of the invention, alternative or complementary to the preceding one, the processing unit 4 is configured to identify, according to said comparison, which among the first N1, the second N2, the third N3 and the fourth node N4 is a neutral node connected to the neutral of the power grid G.

In other words, the neutral node will be that node whose potential corresponds to that of the neutral of the selected grid.

The processing unit 4 is also configured to monitor the first value of the voltage signal on said neutral node and compare said first value with the corresponding reference value of the grid type determined.

When the result of the comparison, i.e., a difference between the first value of the voltage signal on the neutral node and the corresponding reference value, exceeds a predetermined threshold value, then the processing unit is programmed to identify an earth disconnection or or earthing degradation condition, generating a corresponding alarm signal.

In the preferred embodiment, the threshold value is between 5% and 20% of the reference value, preferably around 10%.

Advantageously, this makes it possible to very quickly and cost-effectively identify connection problems with the power grid, immediately securing the system.

Another purpose of this invention is to provide a method of controlling a battery charging device connected to the power grid via a power outlet 3, preferably but not necessarily for the charging device 1 described so far.

In the following, then, the method will be described in more detail, emphasising from the outset that all the features mentioned and described in relation to the device, where not expressly indicated or in case of incompatibility, are to be considered applicable mutatis mutandis to the following description of the method that this invention concerns.

The method comprises detecting the first, second, third and fourth voltage signals on the first N1, the second N2, the third N3 and the fourth node N4.

As described above, these nodes are associated with respective terminals of the power outlet 3 and represent three phase nodes L1, L2, L3 and a neutral node N.

At this point, said voltage signals are processed so as to extract, for each signal, a first and a second value representing a modulus and a phase shift of the voltage flowing in the respective phase node L1, L2, L3 or neutral node N.

These first and second values are those already described in relation to the device, as is preferably also the processing mode (SDFT ed.).

The first and second values are, therefore, preferably compared with respective reference values representing the modules, phase shifts and natural frequencies of a variety of power grid types.

Preferably, even in this case the comparison is made using the information contained in the database 5, which has already been described in great detail above.

The type of power grid G to which the battery charging device 1 is connected is, therefore, determined according to said comparison, by selecting the type of grid to which said first and second values correspond.

The device 1 is, therefore, controlled or configured by adapting it to the determined type of power grid G.

Preferably, the method also includes a cyclic control step following the determination of the network.

This step, at each cycle, involves identifying, according to said comparison, which of the first N1, the second N2, the third N3 and the fourth node N4 is a neutral node connected to the neutral of the power grid G.

The first value of the voltage signal at the neutral node is then cyclically monitored and compared with the corresponding reference value.

At this point, an earth disconnection or earthing degradation condition is identified when a difference between the first voltage signal value on the neutral node and the corresponding reference value exceeds a predetermined threshold value and an alarm signal is generated in response to the identification of said earth disconnection or earthing degradation condition. The preferred ‘threshold value’ has already been discussed above.

The invention achieves its intended purposes and entails important advantages.

In fact, the adoption of a grid type detection system allows the device to maximise both the conversion efficiency, by means of appropriate configuration of the bridges and switches of the converter assembly, and the level of safety, by ensuring prompt identification of faults or earth disconnection.

1-5. (canceled)

6. A battery charging device connectable to a power grid, comprising:
a power outlet provided with a first, a second, a third, and a fourth terminal;
a plurality of voltage sensors associated with a first, a second, a third, and a fourth node connected to said first, said second, said third, and said fourth terminal, respectively, and configured to generate a first, a second, a third, and a fourth voltage signal, each representing a voltage value at the respective node;
a processing unit configured for:
receiving said first, second, third and fourth voltage signals;
processing said voltage signals so as to extract, for each of said first, second, third and fourth signal, a first and a second value representing a module and a phase shift of the voltage flowing in the respective node;
comparing said first and second values with respective reference values representing modules, phase shifts, and natural frequencies of a plurality of types of power grids;
based on said comparison, determining a type of power grid to which the battery charging device is connected, selecting a type of power grid to which said first and second values correspond; and
configuring a topology of the charging device and/or monitoring a state of connection of the device to the power grid according to the type of power grid determined,
wherein said processing unit is also configured for:
based on said comparison, identifying which of the first, second, third and fourth nodes is a neutral node connected to a neutral of the power grid;
monitoring the first value of the voltage signal at said neutral node;
comparing said first value with the corresponding reference value of the type of grid determined;
identifying an earth disconnection or earthing degradation condition when a difference between the first value of the voltage signal at the neutral node and the corresponding reference value exceeds a predetermined threshold value; and
generating an alarm signal in response to the identification of said earth disconnection or earthing degradation condition.

7. The battery charging device according to claim 6, wherein the processing unit is associated with at least one database containing a plurality of parameters identifying each type of electrical network, wherein to each type of electrical network reference values representing the following are associated:
a plausibility range or a point value of the voltage module of each phase node and of a neutral node;
a plausibility range or a point value of a phase shift between the voltages of the phase and/or neutral nodes;
a plausibility range or a point value of the grid frequency;
wherein said processing unit is configured to compare each first or second value with the corresponding reference value of each type of grid.

8. A method of controlling a battery charging device connected to a power grid by means of a power outlet, the method comprising:
detecting a first, a second, a third, and a fourth voltage signal at a first, a second, a third, and a fourth node associated with respective terminals of the power outlet and representing three phase nodes and a neutral node;
processing said voltage signals so as to extract, for each signal, a first and a second value representing a module and a phase shift of the voltage flowing in the respective phase or neutral node;
comparing said first and second values with respective reference values representing the modules, phase shifts, and natural frequencies of a plurality of types of electrical networks;
based on said comparison, determining the type of power grid to which the battery charging device is connected, selecting the type of grid to which said first and second values correspond;
controlling the charging device by adapting it to the type of power grid determined, based on said comparison, identifying which of the first, second, third and fourth nodes is a neutral node connected to the neutral of the power grid;
monitoring the first value of the voltage signal at said neutral node;
comparing said first value with the corresponding reference value;
identifying an earth disconnection or earthing degradation condition when a difference between the first value of the voltage signal at the neutral node and the corresponding reference value exceeds a predetermined threshold value;
generating an alarm signal in response to the identification of said earth disconnection or earthing degradation condition.

9. The method according to claim 8, wherein said step of comparing said first and second values with respective reference values comprises:
providing at least one database containing a plurality of parameters identifying each type of power grid, wherein each type of electrical network is associated with reference values representing:
a plausibility range or a point value of the voltage module of each phase node and of the neutral node;
a plausibility range or a point value of a phase shift between the voltages of the phase and/or neutral nodes;
a plausibility range or a point value of the grid frequency;
comparing each first or second value with the corresponding reference value of each type of grid.

10. The method according to claim 8, wherein said threshold value is between 5% and 20%, preferably approximately 10%, of the reference value.
